(19) United States
(12) Patent Application Publication
(10) Pub. No.: US 2021/0263494 A1
(43) Pub. Date: Aug. 26, 2021

(54) WIRELESS MONITORING DEVICE FOR FLEXIBLE MATERIAL PROCESSING AND CONTROL METHOD THEREOF

(71) Applicant: GUANGDONG UNIVERSITY OF TECHNOLOGY, GUANGZHOU (CN)

(72) Inventors: Yaohua DENG, GUANGZHOU (CN); Qiwen LU, GUANGZHOU (CN)

(73) Assignee: GUANGDONG UNIVERSITY OF TECHNOLOGY

(21) Appl. No.: 17/025,236

(22) Filed: Sep. 18, 2020

(30) Foreign Application Priority Data
Feb. 20, 2020 (CN) 202010104968.4

(51) Int. Cl. G05B 19/18; G05B 19/4155

(52) U.S. Cl. CPC G05B 19/182; G05B 2219/37087; G05B 19/4155

(57) ABSTRACT

Disclosed is a wireless monitoring device for flexible material processing, including a numerical control cutting device, a PC control device, and a smart terminal; the numerical control cutting device includes an equipment controller, a servo system and a cutting module, the equipment controller is communicatively connected with the PC control device, and the equipment controller controls the servo system and the cutting module; the PC control device is communicatively connected with the smart terminal, and the smart terminal includes a control module and a monitoring module. The object of the disclosure is to allow an operator to use the smart terminal to realize mobile monitoring of cutting processing of flexible material, which is more convenient for the operator to operate the cutting machine.

### CROSS-REFERENCE TO RELATED APPLICATIONS

This application claims priority to Chinese Patent Application No. 202010104968.4 with a filing date of Feb. 20, 2020. The content of the aforementioned applications, including any intervening amendments thereto, are incorporated herein by reference.

### TECHNICAL FIELD

The disclosure relates to a flexible material cutting equipment, in particular to a wireless monitoring device for flexible material processing and a control method thereof.

### BACKGROUND OF THE PRESENT INVENTION

The existing flexible material cutting processing is mainly for cropping of clothing and leather, before the cropping processing, the flexible material needs to be manually positioned by grid alignment and strip alignment, according to grid lines projected by a projector on a worktable of a cutting machine, the grid lines and strip lines on the flexible material are aligned with the projected grid lines to determine a placement and cutting positions of the flexible material. Therefore, when operating the flexible material cutting machine, an operator also needs to perform grid alignment and strip alignment of the flexible material, switch between control of the cutting machine and grid alignment and strip alignment of the flexible material, a human machine interaction control terminal of the cutting machine system is placed in a fixed location, it cannot realize a mobile control of the equipment, and cannot allow the operator to operate the equipment in different orientations, which is not convenient for the operator to efficiently operate the cutting machine, and greatly reduces work efficiency and production efficiency.

### SUMMARY OF PRESENT INVENTION

In view of the above-mentioned defects, the object of the disclosure is to allow the operator to use a smart terminal to realize mobile monitoring of cutting processing of flexible material, which is more convenient for an operator to operate the cutting machine.

To achieve this object, the disclosure adopts the following technical solution.

A wireless monitoring device for flexible material processing includes a numerical control cutting device, a PC control device and a smart terminal, the numerical control cutting device includes an equipment controller, a servo system and a cutting module, the equipment controller is communicatively connected with the PC control device, and the equipment controller controls the servo system and the cutting module.

The PC control device is communicatively connected with the smart terminal, and the smart terminal includes a control module and a monitoring module.

Preferably, the numerical control cutting device further includes an air suction system and a sensing module, and both the air suction system and the sensing module are communicatively connected with the equipment controller.

Preferably, the PC control device includes a data processing module and an equipment data acquisition module.

The data module converts control commands and processing files issued by the smart terminal into control instructions by preset process algorithm and motion control algorithm, and sends them to the equipment controller to control the equipment to complete the cutting processing;

The equipment data acquisition module is used to acquire the status data and processing data of the numerical control cutting device, process and analyze the acquired data, and send them to the smart terminal.

Preferably, the smart terminal includes a control module and a monitoring module.

The control module is a module that controls the operation of the equipment, including processing control, manual control, parameter setting, processing file transmission and other functions.

The monitoring module is a module that receives the processing data and status data of the numerical control cutting device sent by the data acquisition module of the PC control device, and displays the processing, fault, position, speed and other information of the cutting device in real time, so as to realize a function of wireless monitoring of the numerical control cutting device on the smart terminal.

Further, the PC control device establishes a connection with the control module of the smart terminal by wireless network communication, receives control commands and processing files sent by the control module of the smart terminal, and converts the control commands and processing files into cutting motion control instructions by the process optimization algorithm, motion control algorithm, and I/O control of the data processing module, and sends them to the equipment controller to control the numerical control cutting device to complete the cutting processing.

Further, the smart terminal is one of a tablet computer, a smart phone, a smart watch, or a mobile computer.

Further, the smart terminal is connected to the PC control device by wifi wireless communication.

Further, the sensing module and the equipment controller are connected by I/O connections.

The air suction system and the equipment controller are connected by RS232 communication.

A control method using an device includes the following steps.

A. control function, by setting the connection IP address and port number of the control module of the smart terminal, wirelessly connecting the smart terminal to the PC control device of an equipment, sending control commands such as processing control, manual control, parameter setting and processing file data to the PC control device by operating the control module of the smart terminal, thereby processed by the data processing module of the PC control device to generate control instructions to control the equipment, thereby wirelessly controlling the numerical control cutting device.

B. monitoring function, acquiring the status data and processing data of the numerical control cutting device by the data acquisition module of the PC control device, processing, analyzing and packaging the acquired data, and then sending them to the smart terminal wirelessly, and by the smart terminal, parsing the data, displaying the processing, fault, position, speed and other information of the cutting device in real time in the form of graph and text, so as to realize a function of wireless monitoring of the numerical control cutting device on the smart terminal.

The beneficial effect of the disclosure is as follows: This solution uses the PC control device to control the numerical control cutting device, and then uses the smart terminal to perform information interaction with the PC control device, so as to realize remote monitoring and remote control of the numerical control cutting device; this solution takes full advantage of the smart equipment, which is convenient for a staff to operate and use the numerical control cutting device. The servo system, air suction system and sensing module of the numerical control cutting device are all connected with the equipment controller, so that status data of the equipment can be acquired by the equipment controller, and then sent to the PC control device, and then uploaded to the smart terminal.

### DESCRIPTION OF THE DRAWINGS

FIG. 1 is an installation structure diagram of one embodiment of the disclosure.

### DETAILED DESCRIPTION OF PREFERRED EMBODIMENTS

The technical solution of the disclosure will be further described below in conjunction with the Drawings and Detailed Description.

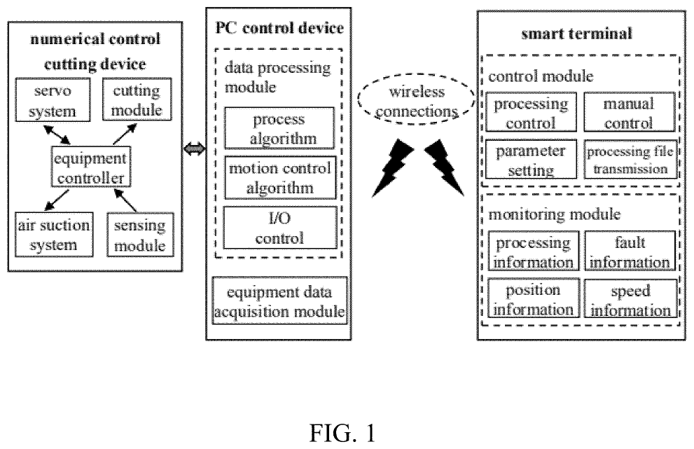

As shown in FIG. 1, a flexible material cutting processing system with wireless monitoring function includes a numerical control cutting device, a PC control device and a smart terminal, the numerical control cutting device includes an equipment controller, a servo system and a cutting module, and the equipment controller controls the servo system and cutting module.

The PC control device is communicatively connected with the smart terminal, and the smart terminal includes a control module and a monitoring module.

This solution uses the PC control device to control the numerical control cutting device, and then uses the smart terminal to perform information interaction with the PC control device, so as to realize remote monitoring and remote control of the numerical control cutting device; this solution takes full advantage of the smart equipment, which is convenient for a staff to operate and use the numerical control cutting device.

Wherein the numerical control cutting device further includes an air suction system and a sensing module, and both the air suction system and the sensing module are communicatively connected with the equipment controller.

The servo system, air suction system and sensing module of the numerical control cutting device are all connected with the equipment controller, so that status data of the equipment can be acquired by the equipment controller, and then sent to the PC control device, and then uploaded to the smart terminal.

Wherein the PC control device includes a data processing module and an equipment data acquisition module.

The data module converts control commands and processing files issued by the smart terminal into control instructions by preset process algorithm and motion control algorithm, and sends them to the equipment controller to control the equipment to complete the cutting processing.

The equipment data acquisition module is used to acquire the status data and processing data of the numerical control cutting device, process and analyze the acquired data, and send them to the smart terminal.

In addition, the smart terminal includes a control module and a monitoring module.

The control module is a module that controls the operation of the equipment, including processing control, manual control, parameter setting, processing file transmission and other functions.

The monitoring module is a module that receives the processing data and status data of the numerical control cutting device sent by the data acquisition module of the PC control device, and displays the processing, fault, position, speed and other information of the cutting device in real time, so as to realize a function of wireless monitoring of the numerical control cutting device on the smart terminal.

In addition, the PC control device establishes a connection with the control module of the smart terminal by wireless network communication, receives control commands and processing files sent by the control module of the smart terminal, and converts the control commands and processing files into cutting motion control instructions by the process optimization algorithm, motion control algorithm, and I/O control of the data processing module, and sends them to the equipment controller to control the numerical control cutting device to complete the cutting processing.

Wherein the smart terminal is one of a tablet computer, a smart phone, a smart watch, or a mobile computer.

Wherein the smart terminal is connected to the PC control device by wifi wireless communication.

Further, the sensing module and the equipment controller are connected by I/O connections;

The air suction system and the equipment controller are connected by RS232 communication.

A control method of the above equipment includes the following steps.

A. control function, by setting the connection IP address and port number of the control module of the smart terminal, wirelessly connecting the smart terminal to the PC control device of an equipment, sending control commands such as processing control, manual control, parameter setting and processing file data to the PC control device by operating the control module of the smart terminal, thereby processed by the data processing module of the PC control device to generate control instructions to control the equipment, thereby wirelessly controlling the numerical control cutting device.

B. monitoring function, acquiring the status data and processing data of the numerical control cutting device by the data acquisition module of the PC control device, processing, analyzing and packaging the acquired data, and then sending them to the smart terminal wirelessly, and by the smart terminal, parsing the data, displaying the processing, fault, position, speed and other information of the cutting device in real time in the form of graph and text, so as to realize a function of wireless monitoring of the numerical control cutting device on the smart terminal.

The technical principle of the disclosure has been described above in conjunction with specific embodiments. These descriptions are only for explaining the principle of the disclosure, and cannot be explained as limiting the protection scope of the disclosure in any way. Based on the explanation here, those skilled in the art can conceive other specific embodiments of the disclosure without creative effort, and these embodiments shall fall within the protection scope of the disclosure.

What is claimed is:

1. A wireless monitoring device for flexible material processing comprising a numerical control cutting device, a PC (Personal Computer) control device and a smart terminal;
wherein the numerical control cutting device comprises an equipment controller, a servo system and a cutting module;
the equipment controller is communicatively connected with the PC control device, and the equipment controller is configured to control the servo system and the cutting module; and
the PC control device is communicatively connected with the smart terminal, and the smart terminal comprises a control module and a monitoring module.

2. The wireless monitoring device of claim 1, wherein the numerical control cutting device further comprises an air suction system and a sensing module; and both the air suction system and the sensing module are communicatively connected with the equipment controller.

3. The wireless monitoring device of claim 2, wherein the PC control device comprises a data processing module and an equipment data acquisition module;
the data module is configured to convert control commands and processing files issued by the smart terminal into control instructions through preset process algorithms and motion control algorithms, and send the control commands to the equipment controller to control the equipment for a completion of the cutting processing; and
the equipment data acquisition module is configured to acquire status data and processing data of the numerical control cutting device, process and analyze the acquired data, and send the processed and analyzed data to the smart terminal.

4. The wireless monitoring device of claim 3, wherein the smart terminal comprises a control module and a monitoring module;
the control module is configured to control an operation of the equipment; the controlling comprises processing control, manual control, parameter setting and processing file transmission; and
the monitoring module is configured to receive processing data and status data of the numerical control cutting device sent by the data acquisition module of the PC control device, and display a processing, fault, position and speed information of the cutting device in real time, so as to realize a function of wireless monitoring of the numerical control the cutting device on the smart terminal.

5. The wireless monitoring device of claim 4, wherein the PC control device is configured to establish a connection with the control module of the smart terminal by wireless network communication, receive control commands and processing files sent by the control module of the smart terminal, and convert the control commands and processing files into cutting motion control instructions by the process optimization algorithm, motion control algorithm, and I/O (Input/Output) control of the data processing module, and further send the control instructions to the equipment controller to control the numerical control the cutting device to complete the cutting processing.

6. The wireless monitoring device of claim 5, wherein the smart terminal is one of a tablet computer, a smart phone or a mobile computer.

7. The wireless monitoring device of claim 6, wherein the smart terminal and the PC control device are connected by wireless communication.

8. The wireless monitoring device of claim 7, wherein the smart terminal is connected to the PC control device through WIFI wireless communication.

9. The wireless monitoring device of claim 1, wherein the sensing module and the equipment controller are connected by I/O connections; and
the air suction system and the equipment controller are connected by RS232 communication.

10. A control method using the device of claim 1, comprising:
A. control method, setting a connection IP address and port number of the control module of the smart terminal;
connecting the smart terminal to the PC control device of an equipment wirelessly;
sending control commands such as processing control, manual control, parameter setting and processing file data to the PC control device by operating the control module of the smart terminal, thereby control instructions for a controlling of the equipment is generated through the processing of the data processing module of the PC control device and a wirelessly controlling of the numerical control cutting device is achieved;
monitoring method,
acquiring the status data and processing data of the numerical control cutting device by the data acquisition module of the PC control device;
processing, analyzing and packaging the acquired data, and sending them to the smart terminal wirelessly;
parsing the data, displaying the processing, fault, position, speed information of the cutting device in real time in the form of graph and text, by the smart terminal, so as to realize a function of wireless monitoring of the numerical control cutting device on the smart terminal.
